(19) United States
(12) Patent Application Publication
(10) Pub. No.: US 2016/0349855 A1
(43) Pub. Date: Dec. 1, 2016

(54) DISPLAY METHOD AND ELECTRONIC DEVICE

(71) Applicants: Beijing Lenovo Software Ltd., Beijing (CN); Lenovo (Beijing) Limited, Beijing (CN)

(72) Inventors: Xiaotian Zhu, Beijing (CN); Yan Gao, Beijing (CN); Hailong Liu, Beijing (CN); Xueqin Jiang, Beijing (CN)

(21) Appl. No.: 14/869,016

(22) Filed: Sep. 29, 2015

(30) Foreign Application Priority Data
May 27, 2015 (CN) 201510280763.0

(51) Int. Cl. G06F 3/023; G09G 3/00

(52) U.S. Cl. CPC G06F 3/0236; G09G 3/002

(57) ABSTRACT

The embodiments of the present disclosure disclose a display method and an electronic device. The method comprises: projecting, by a first display unit, a first content; detecting, by a detection unit, an input operation relative to the first content, wherein a detection range of the detection unit corresponds to a projection range of the first display unit, and a bearing surface for displaying the first content is located within the projection range; judging whether the input operation satisfies a first condition to obtain a judgment result; and projecting a second content based on the judgment result, the second content comprising the first content and a prompt content for prompting that the first condition is satisfied.

### CROSS-REFERENCE TO RELATED APPLICATION(S)

This application claims priority to the Chinese Patent Application No. 201510280763.0, filed on May 27, 2015, entitled “DISPLAY METHOD AND ELECTRONIC DEVICE” which is incorporated herein by reference in its entirety.

### TECHNICAL FIELD

The embodiments of the present disclosure relate to projected keyboard input technology, and more particularly, to a display method and an electronic device.

### BACKGROUND

For convenience of inputting information through a small sized electronic device such as an intelligent mobile phone, the projected keyboard technology is used in the electronic device. Although it is convenient for a user to input information through a projected keyboard, an improper identification condition may occur during use. For example, when a user implements a simultaneous multi-point input operation, an identification failure condition may occur in a case of light projection due to multi-point touch. Further, when a user touches in a position close to a boundary, the identification failure condition may also occur. Such scenario may bring troubles to the user, for example, the user may consider that the projected keyboard or the electronic device per se is broken down, which results in very poor user experience.

### SUMMARY

Therefore, embodiments of the present disclosure provide a display method and an electronic device.

The technical solutions according to the embodiments of the present disclosure are implemented as follows.

A display method comprises:

projecting, by a first display unit, a first content;

detecting, by a detection unit, an input operation relative to the first content, wherein a detection range of the detection unit corresponds to a projection range of the first display unit, and a bearing surface for displaying the first content is located within the projection range;

judging whether the input operation satisfies a first condition to obtain a judgment result; and

projecting a second content based on the judgment result, the second content comprising the first content and a prompt content for prompting that the first condition is satisfied.

In a possible implementation, the first content comprises an array of input identities, and

the method further comprises: projecting, by the first display unit, the array of input identities;

detecting, by the detection unit, an input operation relative to the array of input identities; and

judging whether the input operation relative to the array of input identities satisfies a first condition to obtain a judgment result.

In a possible implementation, projecting, by a first display unit, a first content comprises: projecting the first content with a first parameter; and

projecting a second content comprises:

determining a second parameter for displaying the prompt content; and

continuing displaying the first content with the first parameter and displaying the prompt content with the second parameter.

In a possible implementation, judging whether the input operation satisfies a first condition comprises:

judging whether a difference between position parameters of at least two of multiple input operations is less than or equal to a first threshold or not.

In a possible implementation, judging whether the input operation satisfies a first condition comprises:

judging whether a minimal difference between a position parameter of the input operation and a position parameter of a boundary is less than or equal to a second threshold, the position parameter of the boundary representing the projection range of the first content or not.

An electronic device comprises:

a projector configured to project a first content;

a sensor configured to detect an input operation relative to the first content, wherein a detection range of the sensor corresponds to a projection range of the projector, and a bearing surface for displaying the first content is located within the projection range; and

a processor comprising hardware being configured to judge whether the input operation satisfies a first condition to obtain a judgment result;

wherein

the hardware is further configured to project a second content based on the judgment result, the second content comprising the first content and a prompt content for prompting that the first condition is satisfied.

In a possible implementation, the first content comprises an array of input identities, and

correspondingly, the projector is configured to project the array of input identities;

the sensor is configured to detect an input operation relative to the array of input identities; and

the hardware is configured to judge whether the input operation relative to the array of input identities satisfies a first condition to obtain a judgment result.

In a possible implementation, the projector is further configured to project the first content with a first parameter; and determine a second parameter for displaying the prompt content, continue displaying the first content with the first parameter and display the prompt content with the second parameter.

In a possible implementation, the hardware is further configured to judge whether a difference between position parameters of at least two of multiple input operations is less than or equal to a first threshold or not.

In a possible implementation, the hardware is further configured to judge whether a minimal difference between a position parameter of the input operation and a position parameter of a boundary is less than or equal to a second threshold or not, the position parameter of the boundary representing the projection range of the first content.

In a possible implementation, the bearing surface is a supporting surface, and the electronic device further comprises a display screen, wherein an angle between the display screen and the bearing surface is in a range from 60 degrees to 120 degrees.

In a possible implementation, the electronic device further comprises a display screen further configured to display an input identity corresponding to the input operation.

In a possible implementation, the sensor is further configured to emit detection light on the bearing surface, and determine an input operation relative to the first content according to the received reflected light.

An electronic device is provided comprising:

a first display unit configured to project a first content;

a detection unit configured to detect an input operation relative to the first content, wherein a detection range of the detection unit corresponds to a projection range of the first display unit, and a bearing surface for displaying the first content is located within the projection range;

a judgment unit configured to judge whether the input operation satisfies a first condition to obtain a judgment result; and

a second display unit configured to project a second content based on the judgment result, the second content comprising the first content and a prompt content for prompting that the first condition is satisfied.

In a possible implementation, the electronic device further comprises a determination unit configured to determine a second parameter for displaying the prompt content; wherein,

the first display unit is further configured to project the first content with a first parameter, and continue displaying the first content with the first parameter; and

the second display unit is configured to display the prompt content with the second parameter.

In a possible implementation, the judgment unit is further configured to:

judge whether a difference between position parameters of at least two of multiple input operations is less than or equal to a first threshold; or

judge whether a minimal difference between a position parameter of the input operation and a position parameter of a boundary is less than or equal to a second threshold, the position parameter of the boundary representing the projection range of the first content.

In the embodiments of the present disclosure, a pattern of a keyboard is projected by a projector arranged in an electronic device, and an input operation of a user relative to the projected pattern of the keyboard is detected by a detection unit arranged in the electronic device, and when it is detected that the input operation of the user is implemented on the boundary of the pattern of the keyboard or a distance between input operations is too small to correctly identify the input operation of the user relative to the pattern of the keyboard, a frame of the pattern of the keyboard or another prompt pattern is projected in addition to the projected pattern of the keyboard, so as to prompt the user to implement an operation within the range of the projected pattern or reduce simultaneous multiple input operations. In the embodiments of the present disclosure, the frame of the projected pattern or another pattern is arranged to prompt that the current input operation is not detectable, so as to enable the user to change a current input mode, thereby improving the user experience.

### BRIEF DESCRIPTION OF THE DRAWINGS

FIG. 1 is a flowchart of a display method according to a first embodiment of the present disclosure;

FIG. 2 is a flowchart of a display method according to a second embodiment of the present disclosure;

FIG. 3 is a flowchart of a display method according to a third embodiment of the present disclosure;

FIG. 4 is a flowchart of a display method according to a fourth embodiment of the present disclosure;

FIG. 5 is a structural diagram of constitution of an electronic device according to a first embodiment of the present disclosure; and

FIG. 6 is a structural diagram of constitution of an electronic device according to a second embodiment of the present disclosure.

### DETAILED DESCRIPTION

For more thoroughly understanding the features and technical contents of the present disclosure, the implementations of the present disclosure will be described below in detail in conjunction with accompanying drawings. The accompanying drawings are merely used for reference and illustration instead of limiting the present disclosure.

FIG. 1 is a flowchart of a display method according to a first embodiment of the present disclosure. As shown in FIG. 1, the display method according to the present embodiment comprises the following steps.

In step 101, a first content is projected by a first display unit.

The display method according to the embodiment of the present disclosure is applied in an electronic device. The electronic device is generally a portable electronic device such as a mobile terminal. For example, the electronic device is a small sized electronic device such as a mobile phone, a console, a personal digital assistant or the like. Due to the small size of these electronic devices, an input keyboard arranged in these electronic devices may have a small area. In this case, when a user inputs information through the input keyboard of the electronic device, wrong keys may frequently be pressed, which results in inconvenience. Even for some electronic devices with a display screen as input means instead of an input keyboard, due to the limited area of the display screen, the same problem that the operation is inconvenient may also occur during information input.

In the embodiment of the present disclosure, a first display unit is provided in the electronic device, and projects an input keyboard on a supporting surface of the electronic device in a projection manner, so that the supporting surface is used as a bearing surface for the projected input keyboard. A display area of the projected input keyboard may be controlled by a projection function of the first display unit, for convenience of inputting information by the user. In the embodiment of the present disclosure, the projected first content may be a pattern of the input keyboard, and a display area of the projected pattern of the input keyboard may be controlled by controlling a projection parameter of the first display unit.

The first display content may also be a projected pattern of another input means, for example, a pattern of an array of input etymons for the WuBi input method, a pattern of an array of Hiragana or Katakana in Japanese or the like.

In step 102, an input operation relative to the first content is detected by a detection unit.

A detection range of the detection unit corresponds to a projection range of the first display unit, and a bearing surface for displaying the first content is located within the projection range.

After the pattern of the projected input keyboard is projected, the user may implement an operation on the projected keyboard. For example, the user may touch the display content on the input keyboard with fingers. The electronic device may further have a detection unit such as an infrared detector or the like arranged therein. The detection unit may detect a position of a finger of the user, and determine input information such as a letter to be touched by the user by determining the position of the finger of the user, so that the corresponding information is displayed as an input result of the user on a display screen of the electronic device.

In the present embodiment, the detection range of the detection unit corresponds to the projection range of the first display unit. Alternatively, the detection range of the detection unit is larger than the projection range of the first display unit. A bearing surface for displaying the first content is located within the projection range. In the present embodiment, the bearing surface may be a part of a supporting surface for supporting the electronic device. In some special cases, the supporting surface and the bearing surface may be located in different planes. For example, when the electronic device is supported on a ladder-like object, the supporting surface may be located in a plane above the bearing surface, and the bearing surface is located in a lower plane of the ladder-like object.

In step 103, it is judged whether the input operation satisfies a first condition to obtain a judgment result.

With the projected keyboard, the user experience in information input is greatly improved, and the user may conveniently input information as with the computer keyboard without error information input. However, as the input operation of the user is still detected by the detection unit of the electronic device according to light, when the user inputs a lot of information at the same time and positions of characters corresponding to the input information are close to each other, it is difficult for the detection unit to identify the character information to be input by the user, which results in error input of the user and thus influences the effects in use. In addition, when the input operation is implemented by the user on the boundary of the projected keyboard, the same problem may occur, i.e., it is difficult for the detection unit to identify the character information to be input by the user, which results in error input. In this case, it is necessary to prompt the user that it is difficult for the detection unit of the electronic device to correctly identify the current input manner, so as to enable the user to pay attention to the action of the input operation. For example, the user is prompted to reduce simultaneous input operations or to implement an operation within the projection range of the projected keyboard, thereby improving the correctness of detecting the input operation of the user by the detection unit.

In the present embodiment, the detection unit may judge whether the current input operation of the user cannot be correctly identified. When there are multiple simultaneous input operations of the user and a distance between adjacent ones of characters corresponding to more than two of the multiple input operations is less than a predetermined threshold, a first condition is satisfied. Alternatively, when the input operation is implemented on the boundary of the projected keyboard and a distance between a position where the input operation is implemented and the boundary is less than a predetermined threshold, the first condition is satisfied. In the embodiment of the present disclosure, the judgment of whether the first condition is satisfied is not limited to the above two cases. In all scenarios which result in the input operation of the user being not able to be correctly detected, the first condition is considered to be satisfied.

In step 104, a second content is projected based on the judgment result.

The second content comprises the first content and a prompt content for prompting that the first condition is satisfied.

When the judgment result represents that the current input operation satisfies the first condition, the second content is projected, the second content comprising the first content and a prompt content for prompting that the first condition is satisfied. That is, when the detection unit of the electronic device detects that the input operation of the user cannot be identified, the second content is projected by the first display unit within the projection range. The second content is used to prompt the user that the current input cannot be identified by the detection unit of the electronic device, and the user needs to change the input operation, so that the detection unit of the electronic device may successfully detect the input operation of the user, so as to accurately identify the input operation and enable the character information input by the user to be input into a processing system.

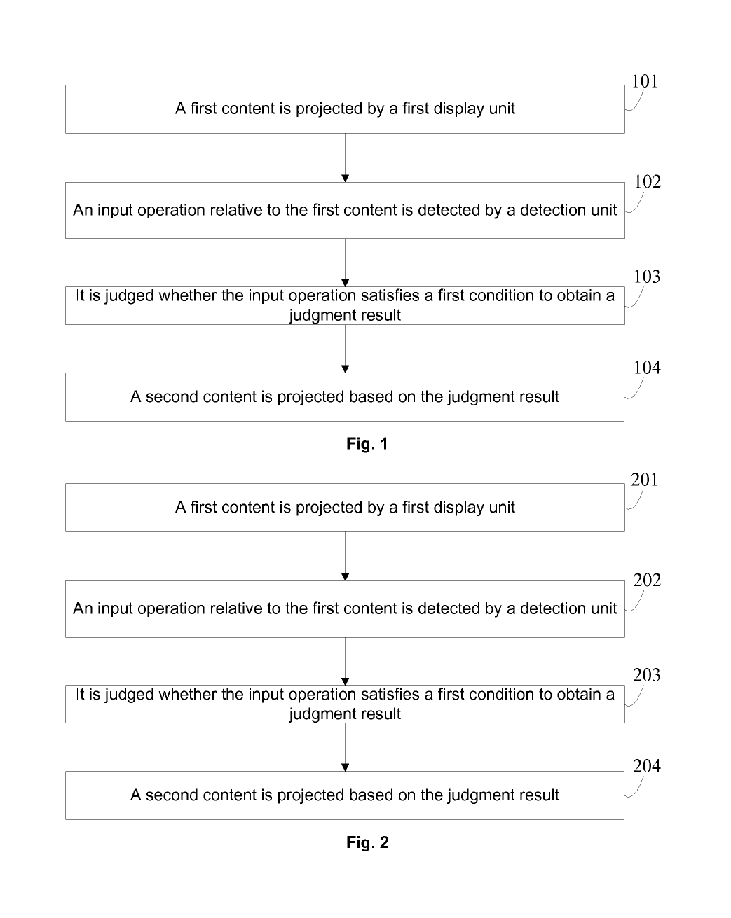

FIG. 2 is a flowchart of a display method according to a second embodiment of the present disclosure. As shown in FIG. 2, the display method according to the present embodiment comprises the following steps.

In step 201, a first content is projected by a first display unit.

The display method according to the embodiment of the present disclosure is applied in an electronic device. The electronic device is generally a portable electronic device such as a mobile terminal. For example, the electronic device is a small sized electronic device such as a mobile phone, a console, a personal digital assistant or the like. Due to the small size of these electronic devices, an input keyboard arranged in these electronic devices may have a small area. In this case, when a user inputs information through the input keyboard of the electronic device, wrong keys may frequently be pressed, which results in inconvenience. Even for some electronic devices with a display screen as input means instead of an input keyboard, due to the limited area of the display screen, the same problem that the operation is inconvenient may also occur during information input.

In the embodiment of the present disclosure, a first display unit is arranged in the electronic device, which projects an input keyboard on a supporting surface of the electronic device in a projection manner, so that the supporting surface is used as a bearing surface for the projected input keyboard. A display area of the projected input keyboard may be controlled by a projection function of the first display unit, for convenience of inputting information by the user.

In the present embodiment, the first content comprises an array of input identities. For example, the first content may be an array of characters of the input keyboard. In an example, the projected array of input identities may completely the same as the characters of the conventional input keyboard of the computer, and are arranged in the same manner as that of the characters of the conventional input keyboard of the computer, which is more convenient for a user to use the array of input identities. Of course, it may be the case that only 26 letters are arranged in the same manner as that of the letters of the conventional keyboard of the computer, and the numerical part is distributed near the letters in another manner, so that it is more convenient for a user to use the projected keyboard. The form of the array of input identities is not limited in the embodiment of the present disclosure, as long as it is convenient for a user to use the projected keyboard. For example, the array of input identities may also be an input array of input etymons for the WuBi input method, and the user may achieve text input by inputting etymons. The array of input identities may also be an array of Hiragana or Katakana in Japanese or the like. It should be noted that the array of input identities of the projected keyboard may be switched by the user as needed. For example, when it needs to input letters, an array of letter identities is projected, and when it needs to input numbers, an array of numerical identities is projected, as long as it is convenient for a user to input information.

In the embodiment of the present disclosure, a display area of the projected pattern of the input keyboard may be controlled by controlling a projection parameter of the first display unit.

In step 202, an input operation relative to the first content is detected by a detection unit.

A detection range of the detection unit corresponds to a projection range of the first display unit, and a bearing surface for displaying the first content is located within the projection range.

In an implementation of the present embodiment, the detection unit emits detection light to the bearing surface, and determines an input operation relative to the first content according to the received reflected light. The detection light may be infrared light or the like. In the embodiment of the present disclosure, the electronic device determines that a user wants to input a corresponding input identity according to an input operation of the user. For example, when the finger of the user touches in a position where a letter “F” is located, it is determined that the user currently wants to input information of “F”. It should be noted that the user may not be completely in contact with the bearing surface on which the projected keyboard is projected, and the input operation may also be detected at a distance from the bearing surface, so that input of a corresponding input identity is achieved. For example, when a distance between the user and the input identity to be input is less than a predetermined threshold such as 0.8 mm, it is conceived that the user wants to input a corresponding input identity. For example, when a finger of the user is to touch in the position where the letter “F” is located, it is determined that the user currently wants to input information of “F”.

After the pattern of the projected input keyboard is projected, the user may implement an operation on the projected keyboard. For example, the user may touch a display content on the input keyboard with fingers. The electronic device may further have a detection unit such as an infrared detector or the like arranged therein. The detection unit may detect a position of a finger of the user, and determine input information such as a letter to be touched by the user by determining the position of the finger of the user, so that the corresponding information is displayed as an input result of the user on a display screen of the electronic device.

In the present embodiment, the detection range of the detection unit corresponds to the projection range of the first display unit. Alternatively, the detection range of the detection unit is larger than the projection range of the first display unit. A bearing surface for displaying the first content is located within the projection range. In the present embodiment, the bearing surface may be a part of a supporting surface for supporting the electronic device. In some special cases, the supporting surface and the bearing surface may be located in different planes. For example, when the electronic device is supported on a ladder-like object, the supporting surface may be located in a plane above the bearing surface, and the bearing surface is located in a lower plane of the ladder-like object.

In step 203, it is judged whether the input operation satisfies a first condition to obtain a judgment result.

With the projected keyboard, the user experience in information input is greatly improved, and the user may conveniently input information as with the computer keyboard without error information input. However, as the input operation of the user is still detected by the detection unit of the electronic device according to light, when the user inputs a lot of information at the same time and positions of characters corresponding to the input information are close to each other, it is difficult for the detection unit to identify the character information to be input by the user, which results in error input of the user and thus influences the effects in use. In addition, when the input operation is implemented by the user on the boundary of the projected keyboard, the same problem may occur, i.e., it is difficult for the detection unit to identify the character information to be input by the user, which results in error input. In this case, it is necessary to prompt the user that it is difficult for the detection unit of the electronic device to correctly identify the current input manner, so as to enable the user to pay attention to the action of the input operation. For example, the user is prompted to reduce simultaneous input operations or to implement an operation within the projection range of the projected keyboard, thereby improving the correctness of detecting the input operation of the user by the detection unit.

In the present embodiment, the detection unit needs to judge whether the current input operation of the user cannot be correctly identified. When there are multiple simultaneous input operations of the user and a distance between adjacent ones of characters corresponding to more than two of the multiple input operations is less than a predetermined threshold, a first condition is satisfied. Alternatively, when the input operation is implemented on the boundary of the projected keyboard and a distance between a position where the input operation is implemented and the boundary is less than a predetermined threshold, the first condition is satisfied. In the embodiment of the present disclosure, the judgment of whether the first condition is satisfied is not limited to the above two cases. In all scenarios which result in the input operation of the user being not able to be correctly detected, the first condition is considered to be satisfied.

In step 204, a second content is projected based on the judgment result.

The second content comprises the first content and a prompt content for prompting that the first condition is satisfied.

When the judgment result represents that the current input operation satisfies the first condition, the second content is projected, the second content comprising the first content and a prompt content for prompting that the first condition is satisfied. That is, when the detection unit of the electronic device detects that the input operation of the user cannot be identified, the second content is projected by the first display unit within the projection range. The second content is used to prompt the user that the current input cannot be identified by the detection unit of the electronic device, and the user needs to change the input operation, so that the detection unit of the electronic device may successfully detect the input operation of the user, so as to accurately identify the input operation and enable the character information input by the user to be input into a processing system.

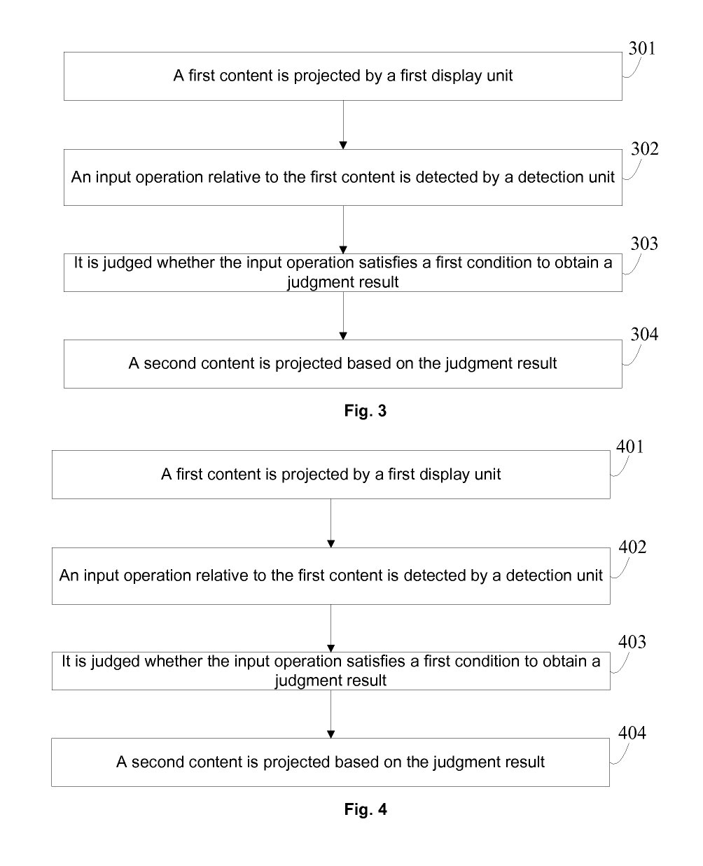

FIG. 3 is a flowchart of a display method according to a third embodiment of the present disclosure. As shown in FIG. 3, the display method according to the present embodiment comprises the following steps.

In step 301, a first content is projected by a first display unit.

The display method according to the embodiment of the present disclosure is applied in an electronic device. The electronic device is generally a portable electronic device such as a mobile terminal. For example, the electronic device is a small sized electronic device such as a mobile phone, a console, a personal digital assistant or the like. Due to the small size of these electronic devices, an input keyboard arranged in these electronic devices may have a small area. In this case, when a user inputs information through the input keyboard of the electronic device, wrong keys may frequently be pressed, which results in inconvenience. Even for some electronic devices with a display screen as input means instead of an input keyboard, due to the limited area of the display screen, the same problem that the operation is inconvenient may also occur during information input.

In the embodiment of the present disclosure, a first display unit is arranged in the electronic device, which projects an input keyboard on a supporting surface of the electronic device in a projection manner, so that the supporting surface is used as a bearing surface for the projected input keyboard. A display area of the projected input keyboard may be controlled by a projection function of the first display unit, for convenience of inputting information by the user.

In the present embodiment, the first content comprises an array of input identities. For example, the first content may be an array of characters of the input keyboard. In an example, the projected array of input identities may completely the same as the characters of the conventional input keyboard of the computer, and are arranged in the same manner as that of the characters of the conventional input keyboard of the computer, which is more convenient for a user to use the array of input identities. Of course, it may be the case that only 26 letters are arranged in the same manner as that of the letters of the conventional keyboard of the computer, and the numerical part is distributed near the letters in another manner, so that it is more convenient for a user to use the projected keyboard. The form of the array of input identities is not limited in the embodiment of the present disclosure, as long as it is convenient for a user to use the projected keyboard. For example, the array of input identities may also be an input array of input etymons for the WuBi input method, and the user may achieve text input by inputting etymons. The array of input identities may also be an array of Hiragana or Katakana in Japanese or the like. It should be noted that the array of input identities of the projected keyboard may be switched by the user as needed. For example, when it needs to input letters, an array of letter identities is projected, and when it needs to input numbers, an array of numerical identities is projected, as long as it is convenient for a user to input information.

In the embodiment of the present disclosure, a display area of the projected pattern of the input keyboard may be controlled by controlling a projection parameter of the first display unit.

In step 302, an input operation relative to the first content is detected by a detection unit.

A detection range of the detection unit corresponds to a projection range of the first display unit, and a bearing surface for displaying the first content is located within the projection range.

In the present embodiment, as an implementation, the detection unit emits detection light to the bearing surface, and determines an input operation relative to the first content according to the received reflected light. The detection light may be infrared light or the like. In the embodiment of the present disclosure, the electronic device determines that a user wants to input a corresponding input identity according to an input operation of the user. For example, when the finger of the user touches in a position where a letter “F” is located, it is determined that the user currently wants to input information of “F”. It should be noted that the user may not be completely in contact with the bearing surface on which the projected keyboard is projected, and the input operation may also be detected at a distance from the bearing surface, so that input of a corresponding input identity is achieved. For example, when a distance between the user and the input identity to be input is less than a predetermined threshold such as 0.8 mm, it is conceived that the user wants to input a corresponding input identity. For example, when a finger of the user is to touch in the position where the letter “F” is located, it is determined that the user currently wants to input information of “F”.

After the pattern of the projected input keyboard is projected, the user may implement an operation on the projected keyboard. For example, the user may touch a display content on the input keyboard with fingers. The electronic device may further have a detection unit such as an infrared detector or the like arranged therein. The detection unit may detect a position of a finger of the user, and determine input information such as a letter to be touched by the user by determining the position of the finger of the user, so that the corresponding information is displayed as an input result of the user on a display screen of the electronic device.

In the present embodiment, the detection range of the detection unit corresponds to the projection range of the first display unit. Alternatively, the detection range of the detection unit is larger than the projection range of the first display unit. A bearing surface for displaying the first content is located within the projection range. In the present embodiment, the bearing surface may be a part of a supporting surface for supporting the electronic device. In some special cases, the supporting surface and the bearing surface may be located in different planes. For example, when the electronic device is supported on a ladder-like object, the supporting surface may be located in a plane above the bearing surface, and the bearing surface is located in a lower plane of the ladder-like object.

In step 303, it is judged whether the input operation satisfies a first condition to obtain a judgment result.

With the projected keyboard, the user experience in information input is greatly improved, and the user may conveniently input information as with the computer keyboard without error information input. However, as the input operation of the user is still detected by the detection unit of the electronic device according to light, when the user inputs a lot of information at the same time and positions of characters corresponding to the input information are close to each other, it is difficult for the detection unit to identify the character information to be input by the user, which results in error input of the user and thus influences the effects in use. In addition, when the input operation is implemented by the user on the boundary of the projected keyboard, the same problem may occur, i.e., it is difficult for the detection unit to identify the character information to be input by the user, which results in error input. In this case, it is necessary to prompt the user that it is difficult for the detection unit of the electronic device to correctly identify the current input manner, so as to enable the user to pay attention to the action of the input operation. For example, the user is prompted to reduce simultaneous input operations or to implement an operation within the projection range of the projected keyboard, thereby improving the correctness of detecting the input operation of the user by the detection unit.

In the present embodiment, the detection unit needs to judge whether the current input operation of the user cannot be correctly identified. When there are multiple simultaneous input operations of the user and a distance between adjacent ones of characters corresponding to more than two of the multiple input operations is less than a predetermined threshold, a first condition is satisfied. Alternatively, when the input operation is implemented on the boundary of the projected keyboard and a distance between a position where the input operation is implemented and the boundary is less than a predetermined threshold, the first condition is satisfied. In the embodiment of the present disclosure, the judgment of whether the first condition is satisfied is not limited to the above two cases. In all scenarios which result in the input operation of the user being not able to be correctly detected, the first condition is considered to be satisfied.

In step 304, a second content is projected based on the judgment result.

The second content comprises the first content and a prompt content for prompting that the first condition is satisfied.

When the judgment result represents that the current input operation satisfies the first condition, the second content is projected, the second content comprising the first content and a prompt content for prompting that the first condition is satisfied. That is, when the detection unit of the electronic device detects that the input operation of the user cannot be identified, the second content is projected by the first display unit within the projection range. The second content is used to prompt the user that the current input cannot be identified by the detection unit of the electronic device, and the user needs to change the input operation, so that the detection unit of the electronic device may successfully detect the input operation of the user, so as to accurately identify the input operation and enable the character information input by the user to be input into a processing system.

In the present embodiment, projecting, by a first display unit, a first content in step 301 comprises projecting the first content with a first parameter. In the embodiment of the present disclosure, when the judgment result represents that the current input operation satisfies the first condition, a second content is projected. Here, projecting a second content comprises: determining a second parameter for displaying the prompt content; and continuing displaying the first content with the first parameter and displaying the prompt content with the second parameter. That is, when it is determined that the input operation of the user cannot be identified, a second content is output, to prompt the user that the current input operation is invalid and the user needs to change the current input operation. In the embodiment of the present disclosure, the second content may be boundary information of the projected keyboard. That is, a frame is further projected in addition to the protected keyboard, and exactly surrounds the projected keyboard, to prompt the user that it needs to implement an operation within the frame. Alternatively, when positional information of input identities of simultaneous operations is less than a predetermined threshold, the second content needs to be set to prompt the user to change the current input operation, for convenience of identification of the current input operation by the detection unit.

In the embodiment of the present disclosure, the first parameter may comprise projection position information, projection color information, information about whether to implement dynamic projection, a projection ratio or the like. Similarly, the second parameter may also comprise projection position information, projection color information, information about whether to implement dynamic projection, a projection ratio or the like. Values of various parameters in the second parameter may be different from values of corresponding parameters in the first parameter, so that the projected second content is different from the first content to distinguish the second content from the first content, thereby prompting the user that there is an error in the current input operation through the second content.

When the first parameter and the second parameter are position parameters, a value of the second parameter is different from that of the first parameter, so that the display position of the second content does not overlap with that of the first content. For example, when the first content is a projected keyboard, the second content may be a frame of the projected keyboard, and the frame exactly surrounds the projected keyboard.

When the first parameter and the second parameter are projection color information, the first parameter has a value of for example 00, which represents a display color of black and white, and the second parameter has a value of for example 02, which represents a display color of one of chromatic colors such as red, so that a display manner of the second content is different from that of the first content, so as to highlight the display of the second content, thereby achieving the purpose of prompting the user.

When the first parameter and the second parameter are information about whether to implement dynamic projection, the second parameter may also have a value different from that of the first parameter, for example, the second parameter has a value of 1 which represents implementing projection in a “flickering” manner and the first parameter has a value of 0 which represents implementing projection in a “static” manner. That is, the first content is projected in a static manner, and the second content is projected in a flickering manner, so as to achieve the purpose of prompting the user.

When the first parameter and the second parameter are projection ratios, the first parameter may also have a value different from that of the second parameter. For example, a value of the second parameter is larger than that of the first parameter, so that the second content is projected with a ratio larger than that for the first content, so as to achieving the purpose of prompting the user.

In the embodiment of the present disclosure, one or more of the above projection parameters of the first content and the second content may be selected. For example, the first content may be distinguished from the second content by not only values of the color parameters, but also by information about whether to implement projection in a flickering manner.

As an implementation manner, when the pattern of the keyboard is projected in black and white and it is determined that the judgment result represents an error existing in the current input operation, a frame of the pattern of the keyboard is projected in red by a first display unit, to prompt the user that the current input operation cannot be correctly detected by the detection unit. Of course, the prompt content may be projected in another manner, for example, prompt information indicating “there is an error in the current input operation” is directly projected as the second content for output, so as to prompt the user to implement an input operation again. In the embodiment of the present disclosure, when the second content is projected, the projected first content is maintained by the first display unit, i.e., the first content is continuously projected in the same manner, to facilitate the user to input information by using the first content.

FIG. 4 is a flowchart of a display method according to a fourth embodiment of the present disclosure. As shown in FIG. 4, the display method according to the present embodiment comprises the following steps.

In step 401, a first content is projected by a first display unit.

The display method according to the embodiment of the present disclosure is applied in an electronic device. The electronic device is generally a portable electronic device such as a mobile terminal. For example, the electronic device is a small sized electronic device such as a mobile phone, a console, a personal digital assistant or the like. Due to the small size of these electronic devices, an input keyboard arranged in these electronic devices may have a small area. In this case, when a user inputs information through the input keyboard of the electronic device, wrong keys may frequently be pressed, which results in inconvenience. Even for some electronic devices with a display screen as input means instead of an input keyboard, due to the limited area of the display screen, the same problem that the operation is inconvenient may also occur during information input.

In the embodiment of the present disclosure, a first display unit is arranged in the electronic device, which projects an input keyboard on a supporting surface of the electronic device in a projection manner, so that the supporting surface is used as a bearing surface for the projected input keyboard. A display area of the projected input keyboard may be controlled by a projection function of the first display unit, for convenience of inputting information by the user.

In the present embodiment, the first content comprises an array of input identities. For example, the first content may be an array of characters of the input keyboard. In an example, the projected array of input identities may completely the same as the characters of the conventional input keyboard of the computer, and are arranged in the same manner as that of the characters of the conventional input keyboard of the computer, which is more convenient for a user to use the array of input identities. Of course, it may be the case that only 26 letters are arranged in the same manner as that of the letters of the conventional keyboard of the computer, and the numerical part is distributed near the letters in another manner, so that it is more convenient for a user to use the projected keyboard. The form of the array of input identities is not limited in the embodiment of the present disclosure, as long as it is convenient for a user to use the projected keyboard. For example, the array of input identities may also be an input array of input etymons for the WuBi input method, and the user may achieve text input by inputting etymons. The array of input identities may also be an array of Hiragana or Katakana in Japanese or the like. It should be noted that the array of input identities of the projected keyboard may be switched by the user as needed. For example, when it needs to input letters, an array of letter identities is projected, and when it needs to input numbers, an array of numerical identities is projected, as long as it is convenient for a user to input information.

In the embodiment of the present disclosure, a display area of the projected pattern of the input keyboard may be controlled by controlling a projection parameter of the first display unit.

In step 402, an input operation relative to the first content is detected by a detection unit.

A detection range of the detection unit corresponds to a projection range of the first display unit, and a bearing surface for displaying the first content is located within the projection range.

In the present embodiment, as an implementation, the detection unit emits detection light to the bearing surface, and determines an input operation relative to the first content according to the received reflected light. The detection light may be infrared light or the like. In the embodiment of the present disclosure, the electronic device determines that a user wants to input a corresponding input identity according to an input operation of the user. For example, when the finger of the user touches in a position where a letter “F” is located, it is determined that the user currently wants to input information of “F”. It should be noted that the user may not be completely in contact with the bearing surface on which the projected keyboard is projected, and the input operation may also be detected at a distance from the bearing surface, so that input of a corresponding input identity is achieved. For example, when a distance between the user and the input identity to be input is less than a predetermined threshold such as 0.8 mm, it is conceived that the user wants to input a corresponding input identity. For example, when a finger of the user is to touch in the position where the letter “F” is located, it is determined that the user currently wants to input information of “F”.

After the pattern of the projected input keyboard is projected, the user may implement an operation on the projected keyboard. For example, the user may touch a display content on the input keyboard with fingers. The electronic device may further have a detection unit such as an infrared detector or the like arranged therein. The detection unit may detect a position of a finger of the user, and determine input information such as a letter to be touched by the user by determining the position of the finger of the user, so that the corresponding information is displayed as an input result of the user on a display screen of the electronic device.

In the present embodiment, the detection range of the detection unit corresponds to the projection range of the first display unit. Alternatively, the detection range of the detection unit is larger than the projection range of the first display unit. A bearing surface for displaying the first content is located within the projection range. In the present embodiment, the bearing surface may be a part of a supporting surface for supporting the electronic device. In some special cases, the supporting surface and the bearing surface may be located in different planes. For example, when the electronic device is supported on a ladder-like object, the supporting surface may be located in a plane above the bearing surface, and the bearing surface is located in a lower plane of the ladder-like object.

In step 403, it is judged whether the input operation satisfies a first condition to obtain a judgment result.

With the projected keyboard, the user experience in information input is greatly improved, and the user may conveniently input information as with the computer keyboard without error information input. However, as the input operation of the user is still detected by the detection unit of the electronic device according to light, when the user inputs a lot of information at the same time and positions of characters corresponding to the input information are close to each other, it is difficult for the detection unit to identify the character information to be input by the user, which results in error input of the user and thus influences the effects in use. In addition, when the input operation is implemented by the user on the boundary of the projected keyboard, the same problem may occur, i.e., it is difficult for the detection unit to identify the character information to be input by the user, which results in error input. In this case, it is necessary to prompt the user that it is difficult for the detection unit of the electronic device to correctly identify the current input manner, so as to enable the user to pay attention to the action of the input operation. For example, the user is prompted to reduce simultaneous input operations or to implement an operation within the projection range of the projected keyboard, thereby improving the correctness of detecting the input operation of the user by the detection unit.

In the present embodiment, as an implementation, judging whether the input operation satisfies a first condition comprises:

judging whether a positional parameter of at least two of multiple input operations is less than or equal to a first threshold. For example, two characters such as W and S are input at the same time with two fingers. However, due to an arrangement of the characters on the keyboard, when W and S are input at the same time, a condition that a finger for inputting W blocks a finger for inputting S may occur, which may result in an operation of inputting a character of S by a user being not able to be detected by the detection unit. Therefore, when multiple input operations are detected by the detection unit and a distance between operation objects such as input characters with respect to at least two of the multiple input operations is less than a predetermined threshold, character information to be input by the user cannot be identified. In this case, it is conceived that the input operation satisfies a first condition, i.e., the detection unit currently cannot correctly detect the input operation of the user.

In the present embodiment, as an implementation, judging whether the input operation satisfies a first condition comprises:

judging whether a minimal difference between a position parameter of the input operation and a position parameter of a boundary is less than or equal to a second threshold, wherein the position parameter of the boundary represents a projection range of the first content.

When a user inputs information through a projected keyboard, there is also such scenario that when the user implements an input operation on the boundary of the projected keyboard, the detection unit may not correctly identify the input operation of the user due to a potential detection blind area. In this case, there is also a need to prompt the user that the current input operation is not a standard operation. Further, a second content such as a frame of the projected keyboard or other prompt information also needs to be projected by the first display unit to prompt the user to implement a standard input operation, so that the detection unit correctly identifies the input operation of the user and character information input by the user is correctly output.

In the present embodiment, the detection unit needs to judge whether the current input operation of the user cannot be correctly identified. When there are multiple simultaneous input operations of the user and a distance between adjacent ones of characters corresponding to more than two of the multiple input operations is less than a predetermined threshold, a first condition is satisfied. Alternatively, when the input operation is implemented on the boundary of the projected keyboard and a distance between a position where the input operation is implemented and the boundary is less than a predetermined threshold, the first condition is satisfied. In the embodiment of the present disclosure, the judgment of whether the first condition is satisfied is not limited to the above two cases. In all scenarios which result in the input operation of the user being not able to be correctly detected, the first condition is considered to be satisfied.

In step 404, a second content is projected based on the judgment result.

The second content comprises the first content and a prompt content for prompting that the first condition is satisfied.

When the judgment result represents that the current input operation satisfies the first condition, the second content is projected, the second content comprising the first content and a prompt content for prompting that the first condition is satisfied. That is, when the detection unit of the electronic device detects that the input operation of the user cannot be identified, the second content is projected by the first display unit within the projection range. The second content is used to prompt the user that the current input cannot be identified by the detection unit of the electronic device, and the user needs to change the input operation, so that the detection unit of the electronic device may successfully detect the input operation of the user, so as to accurately identify the input operation and enable the character information input by the user to be input into a processing system.

In the present embodiment, projecting, by a first display unit, a first content in step 401 comprises projecting the first content with a first parameter. In the embodiment of the present disclosure, when the judgment result represents that the current input operation satisfies the first condition, a second content is projected. Here, projecting a second content comprises: determining a second parameter for displaying the prompt content; and continuing displaying the first content with the first parameter and displaying the prompt content with the second parameter. That is, when it is determined that the input operation of the user cannot be identified, a second content is output, to prompt the user that the current input operation is invalid and the user needs to change the current input operation. In the embodiment of the present disclosure, the second content may be boundary information of the projected keyboard. That is, a frame is further projected in addition to the protected keyboard, and exactly surrounds the projected keyboard, to prompt the user that it needs to implement an operation within the frame. Alternatively, when positional information of input identities of simultaneous operations is less than a predetermined threshold, the second content needs to be set to prompt the user to change the current input operation, for convenience of identification of the current input operation by the detection unit.

In the embodiment of the present disclosure, the first parameter may comprise projection position information, projection color information, information about whether to implement dynamic projection, a projection ratio or the like. Similarly, the second parameter may also comprise projection position information, projection color information, information about whether to implement dynamic projection, a projection ratio or the like. Values of various parameters in the second parameter may be different from values of corresponding parameters in the first parameter, so that the projected second content is different from the first content to distinguish the second content from the first content, thereby prompting the user that there is an error in the current input operation through the second content.

When the first parameter and the second parameter are position parameters, a value of the second parameter is different from that of the first parameter, so that the display position of the second content does not overlap with that of the first content. For example, when the first content is a projected keyboard, the second content may be a frame of the projected keyboard, and the frame exactly surrounds the projected keyboard.

When the first parameter and the second parameter are projection color information, the first parameter has a value of for example 00, which represents a display color of black and white, and the second parameter has a value of for example 02, which represents a display color of one of chromatic colors such as red, so that a display manner of the second content is different from that of the first content, so as to highlight the display of the second content, thereby achieving the purpose of prompting the user.

When the first parameter and the second parameter are information about whether to implement dynamic projection, the second parameter may also have a value different from that of the first parameter, for example, the second parameter has a value of 1 which represents implementing projection in a “flickering” manner and the first parameter has a value of 0 which represents implementing projection in a “static” manner. That is, the first content is projected in a static manner, and the second content is projected in a flickering manner, so as to achieve the purpose of prompting the user.

When the first parameter and the second parameter are projection ratios, the first parameter may also have a value different from that of the second parameter. For example, a value of the second parameter is larger than that of the first parameter, so that the second content is projected with a ratio larger than that for the first content, so as to achieving the purpose of prompting the user.

In the embodiment of the present disclosure, one or more of the above projection parameters of the first content and the second content may be selected. For example, the first content may be distinguished from the second content by not only values of the color parameters, but also by information about whether to implement projection in a flickering manner.

In the embodiment of the present disclosure, after the first content such as the projected keyboard is projected, a display effect of the first content is generally not changed. For the purpose of attracting attention of the user, the second content for prompting the user that there is an error in the current input operation may have a different value of a projection parameter from that of the first content, so that the second content may be distinguished from the first content to achieve the purpose of prompting for optimization through the second content.

As an implementation, in the embodiment of the present disclosure, the second content may be boundary information of a projected keyboard. That is, a frame is further projected in addition to the projected keyboard, to prompt the user that it needs to implement an operation within the frame, and to prompt the user to change the current input operation when a difference between positions of the input identities of simultaneous operations is less than a predetermined threshold, for convenience of identification of the current input operation by the detection unit. In the embodiment of the present disclosure, the second parameter may comprise projection position information, projection color information, information about whether to implement dynamic projection, a projection ratio or the like. Values of various parameters in the second parameter may be different from values of corresponding parameters in the first parameter, so that the projected second content is different from the first content to distinguish the second content from the first content, thereby prompting the user that there is an error in the current input operation through the second content. For example, when the pattern of the keyboard is projected in black and white and it is determined that the judgment result represents an error existing in the current input operation, a frame of the pattern of the keyboard is projected in red by a first display unit, to prompt the user that the current input operation cannot be correctly detected by the detection unit. Of course, the prompt content may be projected in another manner, for example, prompt information indicating “there is an error in the current input operation” is directly projected as the second content for output, so as to prompt the user to implement an input operation again. In the embodiment of the present disclosure, when the second content is projected, the projected first content is maintained by the first display unit, i.e., the first content is continuously projected in the same manner, to facilitate the user to input information by using the first content.

In the embodiment of the present disclosure, a prompt content may be triggered in any state, for example, when an electric quantity of the electronic device is lower than a threshold, when a processor of the electronic device is at a temperature higher than a threshold, when a certain application of the electronic device transmits a state switch instruction, when a download operation has been completed or the like. The present disclosure is not limited to project a second content only after there is an error in an input operation of the user relative to the projected keyboard.

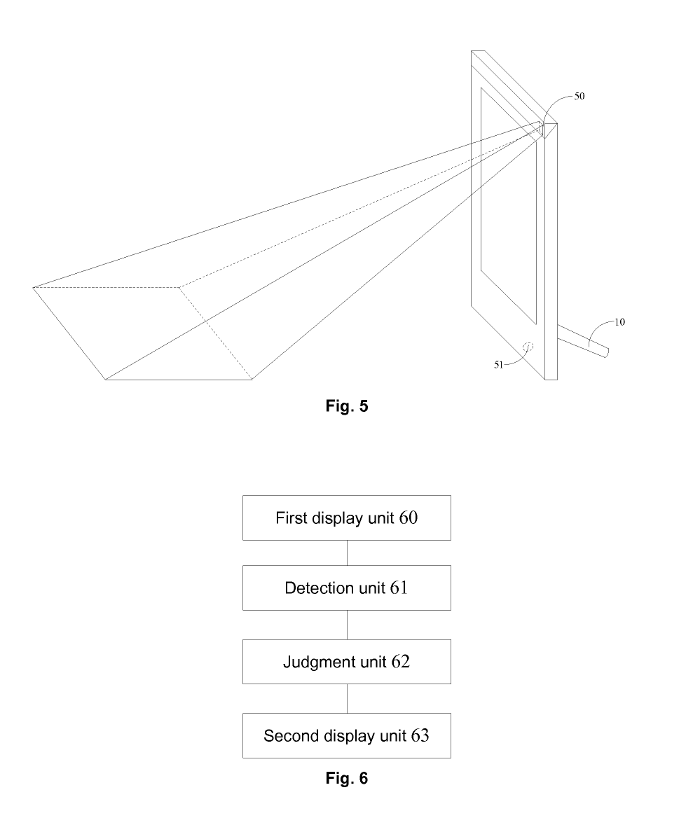

FIG. 5 is a structural diagram of constitution of an electronic device according to a first embodiment of the present disclosure. As shown in FIG. 5, the electronic device according to the present embodiment comprises:

a projector 50 configured to project a first content;

a sensor 51 configured to detect an input operation relative to the first content, wherein a detection range of the sensor corresponds to a projection range of the projector, and a bearing surface for displaying the first content is located within the projection range; and

a processor (not shown in FIG. 5) configured to judge whether the input operation satisfies a first condition to obtain a judgment result; wherein,

the projector 50 is further configured to project a second content based on the judgment result, the second content comprising the first content and a prompt content for prompting that the first condition is satisfied.

In the embodiment of the present disclosure, the electronic device is supported on the supporting surface by a supporting member 10. The supporting surface may be a desktop or the like. In the embodiment of the present disclosure, the supporting member 10 may be arranged on a front panel or a back panel of the electronic device. When there is no need to use the supporting member 10, the supporting member 10 is accommodated into an accommodating space of the electronic device. When there is a need to support the electronic device by using the supporting member 10, the supporting member 10 is extracted from the accommodating space to support the electronic device on a plane.

In the embodiment of the present disclosure, a projector 50 is arranged in the electronic device, which projects a first content such as an input keyboard on a supporting surface of the electronic device in a projection manner, so that the supporting surface is used as a bearing surface for the projected input keyboard. A display area of the projected input keyboard may be controlled by a projection function of the projector 50, for convenience of inputting information by the user.

In the embodiment of the present disclosure, the sensor 51 is arranged in a lower part of the electronic device, and is configured to detect an input operation of the user relative to the first content projected by the projector by emitting detection light such as infrared light or the like to a projection area of the projector 50.

After the pattern of the first content such as the projected input keyboard or the like is projected by the projector 50, the user may implement an operation on the projected keyboard, i.e., pressing a display content on the input keyboard with a finger. The sensor 51 such as an infrared detector or the like in the electronic device may detect a position of the finger of the user, and determine input information such as a letter to be touched by the user by determining the position of the finger of the user, so that the corresponding information is displayed as an input result of the user on a display screen of the electronic device.

In the present embodiment, the detection range of the sensor 51 corresponds to the projection range of the projector 50. Alternatively, the detection range of the sensor 51 is larger than the projection range of the projector 50. A bearing surface for displaying the first content is located within the projection range. In the present embodiment, the bearing surface may be a part of a supporting surface for supporting the electronic device. In some special cases, the supporting surface and the bearing surface may be located in different planes. For example, when the electronic device is supported on a ladder-like object, the supporting surface may be located in a plane above the bearing surface, and the bearing surface is located in a lower plane of the ladder-like object.

Specifically, the sensor 51 emits detection light to the bearing surface, and determines an input operation relative to the first content such as the projected keyboard according to the received reflected light. The detection light may be infrared light or the like. In the embodiment of the present disclosure, a processor determines that a user is to input a corresponding input identity according to the input operation of the user detected by the sensor 51. For example, when the finger of the user touches in a position where a letter “F” is located, it is determined that the user currently wants to input information of “F”. It should be noted that the user may not be completely in contact with the bearing surface on which the projected keyboard is projected, and the input operation may also be detected at a distance from the bearing surface, so that input of a corresponding input identity is achieved. For example, when a distance between the user and the input identity to be input is less than a predetermined threshold such as 0.8 mm, it is conceived that the user wants to input a corresponding input identity. For example, when a finger of the user is to touch in the position where the letter “F” is located, it is determined that the user currently wants to input information of “F”.

When the sensor 51 detects the input identity input by the user, the identified input identity is displayed on the display screen as input information of the user.

The processor, as a core component of the electronic device, is configured to control and manage other components of the electronic device, and output a response result in response to a control instruction input by the user. The processor is not shown in FIG. 5.

After the projector 50 of the electronic device is started, a first content is projected by the projector 50 to the supporting surface of the electronic device. The first content comprises an array of input identities.

For example, the first content may be an array of characters of the input keyboard. In an example, the projected array of input identities may completely the same as the characters of the conventional input keyboard of the computer, and are arranged in the same manner as that of the characters of the conventional input keyboard of the computer, which is more convenient for a user to use the array of input identities. Of course, it may be the case that only 26 letters are arranged in the same manner as that of the letters of the conventional keyboard of the computer, and the numerical part is distributed near the letters in another manner, so that it is more convenient for a user to use the projected keyboard. The form of the array of input identities is not limited in the embodiment of the present disclosure, as long as it is convenient for a user to use the projected keyboard. For example, the array of input identities may also be an input array of input etymons for the WuBi input method, and the user may achieve text input by inputting etymons. The array of input identities may also be an array of Hiragana or Katakana in Japanese or the like. It should be noted that the array of input identities of the projected keyboard may be switched by the user as needed. For example, when it needs to input letters, an array of letter identities is projected, and when it needs to input numbers, an array of numerical identities is projected, as long as it is convenient for a user to input information.

In the embodiment of the present disclosure, the projector 51 is further configured to project the first content with a first parameter; and determine a second parameter for displaying the prompt content, continue displaying the first content with the first parameter, and display the prompt content with the second parameter.

In the embodiment of the present disclosure, the first parameter may comprise projection position information, projection color information, information about whether to implement dynamic projection, a projection ratio or the like. Similarly, the second parameter may also comprise projection position information, projection color information, information about whether to implement dynamic projection, a projection ratio or the like. Values of various parameters in the second parameter may be different from values of corresponding parameters in the first parameter, so that the projected second content is different from the first content to distinguish the second content from the first content, thereby prompting the user that there is an error in the current input operation through the second content.

When the first parameter and the second parameter are position parameters, a value of the second parameter is different from that of the first parameter, so that the display position of the second content does not overlap with that of the first content. For example, when the first content is a projected keyboard, the second content may be a frame of the projected keyboard, and the frame exactly surrounds the projected keyboard.

When the first parameter and the second parameter are projection color information, the first parameter has a value of for example 00, which represents a display color of black and white, and the second parameter has a value of for example 02, which represents a display color of one of chromatic colors such as red, so that a display manner of the second content is different from that of the first content, so as to highlight the display of the second content, thereby achieving the purpose of prompting the user.

When the first parameter and the second parameter are information about whether to implement dynamic projection, the second parameter may also have a value different from that of the first parameter, for example, the second parameter has a value of 1 which represents implementing projection in a “flickering” manner and the first parameter has a value of 0 which represents implementing projection in a “static” manner. That is, the first content is projected in a static manner, and the second content is projected in a flickering manner, so as to achieve the purpose of prompting the user.

When the first parameter and the second parameter are projection ratios, the first parameter may also have a value different from that of the second parameter. For example, a value of the second parameter is larger than that of the first parameter, so that the second content is projected with a ratio larger than that for the first content, so as to achieving the purpose of prompting the user.

In the embodiment of the present disclosure, one or more of the above projection parameters of the first content and the second content may be selected. For example, the first content may be distinguished from the second content by not only values of the color parameters, but also by information about whether to implement projection in a flickering manner.

In the embodiment of the present disclosure, the processor is further configured to judge whether a difference between position parameters of at least two of the multiple input operations is less than a first threshold. For example, two characters such as W and S are input at the same time with two fingers. However, due to an arrangement of the characters on the keyboard, when W and S are input at the same time, a condition that a finger for inputting W blocks a finger for inputting S may occur, which may result in an operation of inputting a character of S by a user being not able to be detected by the detection unit. Therefore, when multiple input operations are detected by the detection unit and a distance between operation objects such as input characters with respect to at least two of the multiple input operations is less than a predetermined threshold, character information to be input by the user cannot be identified. In this case, it is conceived that the input operation satisfies a first condition, i.e., the detection unit currently cannot correctly detect the input operation of the user.

Alternatively, the processor is further configured to judge whether a minimal difference between a position parameter of the input operation and a position parameter of a boundary is less than or equal to a second threshold, wherein the position parameter of the boundary represents a projection range of the first content. Specifically, when a user inputs information through a projected keyboard, there is also such scenario that when the user implements an input operation on the boundary of the projected keyboard, the detection unit may not correctly identify the input operation of the user due to a potential detection blind area. In this case, there is also a need to prompt the user that the current input operation is not a standard operation. Further, a second content such as a frame of the projected keyboard or other prompt information also needs to be projected by the first display unit to prompt the user to implement a standard input operation, so that the detection unit correctly identifies the input operation of the user and character information input by the user is correctly output.

In the embodiment of the present disclosure, the bearing surface is a supporting surface. The electronic device further comprises a display screen, and an angle between the display screen and the bearing surface is in a range from 60 degrees to 120 degrees. Preferably, the angle between the display screen and the bearing surface is 65 degrees, 75 degrees, 80 degrees, or 115 degrees. The angle between the display screen and the bearing surface is preferably an angle suitable for viewing the display screen by a user.

FIG. 6 is a structural diagram of constitution of an electronic device according to a second embodiment of the present disclosure. As shown in FIG. 6, the electronic device according to the present embodiment comprises a first display unit 60, a detection unit 61, a judgment unit 62, and a second display unit 63, wherein,

the first display unit 60 is configured to project a first content;

the detection unit 61 is configured to detect an input operation relative to the first content, wherein a detection range of the detection unit corresponds to a projection range of the first display unit, and a bearing surface for displaying the first content is located within the projection range;

the judgment unit 62 is configured to judge whether the input operation satisfies a first condition to obtain a judgment result; and

the second display unit 63 is configured to project a second content based on the judgment result, the second content comprising the first content and a prompt content for prompting that the first condition is satisfied.

In the embodiment of the present disclosure, the first display unit 60 and the second display unit 63 may be the same component, for example, a projector arranged in the electronic device. Of course, the first display unit 60 and the second display unit 63 may also be different components, for example, different projectors arranged in the electronic device. In terms of implementation cost, it is preferable that the first display unit 60 and the second display unit 63 are the same component.

For example, the first content may be an array of characters of the input keyboard. In an example, the projected array of input identities may completely the same as the characters of the conventional input keyboard of the computer, and are arranged in the same manner as that of the characters of the conventional input keyboard of the computer, which is more convenient for a user to use the array of input identities. Of course, it may be the case that only 26 letters are arranged in the same manner as that of the letters of the conventional keyboard of the computer, and the numerical part is distributed near the letters in another manner, so that it is more convenient for a user to use the projected keyboard. The form of the array of input identities is not limited in the embodiment of the present disclosure, as long as it is convenient for a user to use the projected keyboard. For example, the array of input identities may also be an input array of input etymons for the WuBi input method, and the user may achieve text input by inputting etymons. The array of input identities may also be an array of Hiragana or Katakana in Japanese or the like. It should be noted that the array of input identities of the projected keyboard may be switched by the user as needed. For example, when it needs to input letters, an array of letter identities is projected, and when it needs to input numbers, an array of numerical identities is projected, as long as it is convenient for a user to input information.

On the basis of the electronic device illustrated in FIG. 6, the electronic device according to the embodiment of the present disclosure further comprises a determination unit (not shown in FIG. 6), configured to determine a second parameter for displaying the prompt content;

the first display unit 60 is further configured to project the first content with a first parameter, and continue displaying the first content with the first parameter;

the second display unit 63 is configured to display the prompt content with the second parameter.

In the embodiment of the present disclosure, the first parameter may comprise projection position information, projection color information, information about whether to implement dynamic projection, a projection ratio or the like. Similarly, the second parameter may also comprise projection position information, projection color information, information about whether to implement dynamic projection, a projection ratio or the like. Values of various parameters in the second parameter may be different from values of corresponding parameters in the first parameter, so that the projected second content is different from the first content to distinguish the second content from the first content, thereby prompting the user that there is an error in the current input operation through the second content.

When the first parameter and the second parameter are position parameters, a value of the second parameter is different from that of the first parameter, so that the display position of the second content does not overlap with that of the first content. For example, when the first content is a projected keyboard, the second content may be a frame of the projected keyboard, and the frame exactly surrounds the projected keyboard.

When the first parameter and the second parameter are projection color information, the first parameter has a value of for example 00, which represents a display color of black and white, and the second parameter has a value of for example 02, which represents a display color of one of chromatic colors such as red, so that a display manner of the second content is different from that of the first content, so as to highlight the display of the second content, thereby achieving the purpose of prompting the user.

When the first parameter and the second parameter are information about whether to implement dynamic projection, the second parameter may also have a value different from that of the first parameter, for example, the second parameter has a value of 1 which represents implementing projection in a “flickering” manner and the first parameter has a value of 0 which represents implementing projection in a “static” manner. That is, the first content is projected in a static manner, and the second content is projected in a flickering manner, so as to achieve the purpose of prompting the user.

When the first parameter and the second parameter are projection ratios, the first parameter may also have a value different from that of the second parameter. For example, a value of the second parameter is larger than that of the first parameter, so that the second content is projected with a ratio larger than that for the first content, so as to achieving the purpose of prompting the user.

In the embodiment of the present disclosure, one or more of the above projection parameters of the first content and the second content may be selected. For example, the first content may be distinguished from the second content by not only values of the color parameters, but also by information about whether to implement projection in a flickering manner.

In the embodiment of the present disclosure, the judgment unit 62 is further configured to judge whether a difference between position parameters of at least two of the multiple input operations is less than a first threshold. For example, two characters such as W and S are input at the same time with two fingers. However, due to an arrangement of the characters on the keyboard, when W and S are input at the same time, a condition that a finger for inputting W blocks a finger for inputting S may occur, which may result in an operation of inputting a character of S by a user being not able to be detected by the detection unit. Therefore, when multiple input operations are detected by the detection unit and a distance between operation objects such as input characters with respect to at least two of the multiple input operations is less than a predetermined threshold, character information to be input by the user cannot be identified. In this case, it is conceived that the input operation satisfies a first condition, i.e., the detection unit currently cannot correctly detect the input operation of the user.

Alternatively, the judgment unit 62 is further configured to judge whether a minimal difference between a position parameter of the input operation and a position parameter of a boundary is less than or equal to a second threshold, wherein the position parameter of the boundary represents a projection range of the first content. For example, when the user inputs information through a projected keyboard, there is also such scenario that when the user implements an input operation on the boundary of the projected keyboard, the detection unit may not correctly identify the input operation of the user due to a potential detection blind area. In this case, there is also a need to prompt the user that the current input operation is not a standard operation. Further, a second content such as a frame of the projected keyboard or other prompt information also needs to be projected by the first display unit to prompt the user to implement a standard input operation, so that the detection unit correctly identifies the input operation of the user and character information input by the user is correctly output. Those skilled in the art should understand that the implementation functions of various units in the electronic device illustrated in FIG. 6 may be understood with reference to related description of the display method above. The functions of various units in the above electronic device may be implemented by programs executing on a processor, or may also be implemented by specific logic circuits.

The technical solutions according to the various embodiments of the present disclosure can be combined with each other.

It should be understood that the methods and intelligent devices disclosed in the embodiments of the present disclosure may be implemented in other manners. The device embodiments as described above are merely illustrative. For example, the division of the units is merely a logically functional division, and in practice, there may be other division manners. For example, multiple units or components may be combined or may be integrated into another system, or some features may be ignored or may not be implemented. In addition, various constituent parts, which are displayed or discussed as being coupled or communicatively connected directly, may also be coupled or communicatively connected indirectly via some interfaces, devices or units in an electrical manner, a mechanical manner, or other manners.

The above units described as separate components may be or may not be separated physically. The components displayed as units may be or may not be physical units, i.e., they may be located in a place or may also be distributed among multiple network units. A part or all of the units may be selected as needed to achieve the purpose of the solutions of the embodiments.

In addition, various functional units according to the embodiments of the present disclosure may all be integrated into a processing module, or various units may be used separately, or two or more units are integrated into a unit. The above integrated units may be implemented by hardware or by hardware and software functional units.

The above description is merely specific embodiments of the present disclosure, and the scope of the present disclosure is not limited thereto. Changes or substitutions, which can be obviously envisaged by those skilled persons in the art, should be included in the scope of the present disclosure without departing the scope defined by the appended claims.

I/We claim:

1. A display method, comprising:
projecting, by a first display unit, a first content;
detecting, by a detection unit, an input operation relative to the first content, wherein a detection range of the detection unit corresponds to a projection range of the first display unit, and a bearing surface for displaying the first content is located within the projection range;
judging whether the input operation satisfies a first condition to obtain a judgment result; and
projecting a second content based on the judgment result, the second content comprising the first content and a prompt content for prompting that the first condition is satisfied.

2. The method according to claim 1, wherein the first content comprises an array of input identities, and the method further comprises:
projecting, by the first display unit, the array of input identities;
detecting, by the detection unit, an input operation relative to the array of input identities; and
judging whether the input operation relative to the array of input identities satisfies a first condition to obtain a judgment result.

3. The method according to claim 1, wherein projecting, by a first display unit, a first content comprises:
projecting the first content with a first parameter; and
projecting a second content comprises:
determining a second parameter for displaying the prompt content; and
continuing displaying the first content with the first parameter and displaying the prompt content with the second parameter.

4. The method according to claim 1, wherein judging whether the input operation satisfies a first condition comprises:
judging whether a difference between position parameters of at least two of multiple input operations is less than or equal to a first threshold.

5. The method according to claim 1, wherein judging whether the input operation satisfies a first condition comprises:
judging whether a minimal difference between a position parameter of the input operation and a position parameter of a boundary is less than or equal to a second threshold, the position parameter of the boundary representing the projection range of the first content.

6. An electronic device, comprising:
a projector configured to project a first content;
a sensor configured to detect an input operation relative to the first content, wherein a detection range of the sensor corresponds to a projection range of the projector, and a bearing surface for displaying the first content is located within the projection range; and
a processor configured to:
judge whether the input operation satisfies a first condition to obtain a judgment result;
control the projector to project a second content based on the judgment result, the second content comprising the first content and a prompt content for prompting that the first condition is satisfied.

7. The electronic device according to claim 6, wherein the first content comprises an array of input identities;
the projector is configured to project the array of input identities;
the sensor is configured to detect an input operation relative to the array of input identities; and
the processor is configured to judge whether the input operation relative to the array of input identities satisfies a first condition to obtain a judgment result.

8. The electronic device according to claim 6, wherein the projector is further configured to project the first content with a first parameter; and determine a second parameter for displaying the prompt content, continue displaying the first content with the first parameter and display the prompt content with the second parameter.

9. The electronic device according to claim 6, wherein the processor is further configured to judge whether a difference between position parameters of at least two of multiple input operations is less than or equal to a first threshold.

10. The electronic device according to claim 6, wherein the processor is further configured to judge whether a minimal difference between a position parameter of the input operation and a position parameter of a boundary is less than or equal to a second threshold, the position parameter of the boundary representing the projection range of the first content.

11. The electronic device according to claim 6, wherein the bearing surface is a supporting surface, and the electronic device further comprises a display screen, wherein an angle between the display screen and the bearing surface is in a range from 60 degrees to 120 degrees.

12. The electronic device according to claim 7, further comprising a display screen for displaying an input identity corresponding to the input operation.

13. The electronic device according to claim 6, wherein the sensor is further configured to emit detection light on the bearing surface, and determine an input operation relative to the first content upon receiving reflected light.

14. An electronic device, comprising:
a first display unit configured to project a first content;
a detection unit configured to detect an input operation relative to the first content, wherein a detection range of the detection unit corresponds to a projection range of the first display unit, and a bearing surface for displaying the first content is located within the projection range;
a judgment unit configured to judge whether the input operation satisfies a first condition to obtain a judgment result; and
a second display unit configured to project a second content based on the judgment result, the second content comprising the first content and a prompt content for prompting that the first condition is satisfied.

15. The electronic device according to claim 14, further comprising a determination unit configured to determine a second parameter for displaying the prompt content; wherein,
the first display unit is further configured to project the first content with a first parameter, and continue displaying the first content with the first parameter; and
the second display unit is configured to display the prompt content with the second parameter.

16. The electronic device according to claim 14, wherein the judgment unit is further configured to:
judge whether a difference between position parameters of at least two of multiple input operations is less than or equal to a first threshold; or
judge whether a minimal difference between a position parameter of the input operation and a position parameter of a boundary is less than or equal to a second threshold, the position parameter of the boundary representing the projection range of the first content.
